(19) United States
(12) Patent Application Publication
(10) Pub. No.: US 2018/0354405 A1
(43) Pub. Date: Dec. 13, 2018

(54) LIGHTING ASSEMBLY AND METHODS THEREFOR

(71) Applicant: Myotek Pacific Corp., Laguna Beach, CA (US)

(72) Inventors: Robert T. Harrington, JR., Laguna Beach, CA (US); Jeyachandrabose Chinniah, Katy, TX (US)

(21) Appl. No.: 15/621,200

(22) Filed: Jun. 13, 2017

(51) Int. Cl. B60Q 1/04; F21V 19/02; B60Q 1/068; G01M 11/06

(52) U.S. Cl. CPC B60Q 1/0483; F21V 19/02; B60Q 2300/132; G01M 11/06; B60Q 1/0686

(57) ABSTRACT

A method of illumination includes energizing a light source of a lighting apparatus to emit a plurality of light rays. The method also includes directing a first light ray of the plurality of light rays into a first upper passageway. The method also includes directing a second light ray of the plurality of light rays into a first lower passageway. The method also includes redirecting the first light ray from the first upper passageway into a second upper passageway. The method also includes redirecting the second light ray from the second upper passageway into a second lower passageway.

### BACKGROUND

Vehicles, for example automobiles, generally include a number of lights to illuminate an area in front of the vehicle during certain conditions. Low-beam headlights may be used in dark conditions, i.e. at night or inclement weather like rain or snow. High-beam headlights may be utilized during especially dark conditions to provide additional illumination in comparison to low-beam headlights. Fog lights provide illumination during foggy conditions and are angled to prevent light from reflecting back toward the vehicle. Additionally, light pipes or light guides may be utilized to add aesthetics to the vehicle. Light pipes and light guides also provide visibility of the vehicle to other vehicles.

Generally, light pipes are illuminated by energizing a light source at each end of the light pipe, for example a light emitting diode (LED), at an end of the pipe. The pipe carries the light rays from the light source along a length of the pipe, thereby resulting in the loss of illumination on the light pipe as the light reaches an end of the pipe proximate to the light source. As an alternative to light pipes, a light guide may be used wherever the light of a light source should be distributed homogeneously over a particular area and there is a spatial distance between light source and the area which is to be illuminated.

### SUMMARY

The present application discloses one or more of the features recited in the appended claims and/or the following features which, alone or in any combination, may comprise patentable subject matter:

In one aspect, a method of illumination includes energizing a light source of a lighting apparatus to emit a plurality of light rays. The light source is positioned in a plane when the lighting apparatus is viewed in a cross-sectional plane. The method also includes directing a first light ray of the plurality of light rays into a first upper passageway positioned above the plane. The first upper passageway has a longitudinal plane that extends at a first angle relative to the plane when the lighting apparatus is viewed in the cross-sectional plane. The method also includes directing a second light ray of the plurality of light rays into a first lower passageway positioned below the plane opposite the first upper passageway. The first lower passageway has a longitudinal plane that extends at the first angle relative to the plane when the lighting apparatus is viewed in the cross-sectional plane. The method also includes redirecting the first light ray from the first upper passageway into a second upper passageway positioned above the plane. The second upper passageway has a longitudinal plane that extends at a second angle relative to the plane when the lighting apparatus is viewed in the cross-sectional plane. The method also includes redirecting the second light ray from the second upper passageway into a second lower passageway positioned below the plane. The second lower passageway has a longitudinal plane that extends at the second angle relative to the plane when the lighting apparatus is viewed in the cross-sectional plane. The first light ray exits the lighting apparatus through an upper exit surface positioned at an end of the second upper passageway and the second light ray exits the lighting apparatus through a lower exit surface positioned at an end of the second lower passageway.

In some embodiments, the method also includes energizing the light source to emit the plurality of light rays through a surface that defines a notch in which the light source is positioned. In some embodiments, the method also includes directing the first light ray into the first upper passageway with the base surface. In some embodiments, the method also includes directing the second light ray into the first lower passageway with the base surface. In some embodiments the method also includes refracting the first light ray into the first upper passageway with the base surface. In some embodiments, the method also includes refracting the second light ray into the first lower passageway with the base surface.

In some embodiments, the method also includes internally reflecting the first light ray through the first upper passageway. In some embodiments, the method also includes internally reflecting the second light ray through the first lower passageway. In some embodiments, the method also includes internally reflecting the first light ray through the second upper passageway. In some embodiments, the method also includes internally reflecting the second light ray through the second lower passageway.

In another aspect, a lighting apparatus includes a light source configured to emit a plurality of light rays. The light source is positioned in a plane when the lighting apparatus is viewed in a cross-sectional plane. A first upper passageway is positioned above the plane and has a longitudinal plane that extends at a first angle relative to the plane when the lighting apparatus is viewed in the cross-sectional plane. The first upper passageway is sized and shaped to receive a first light ray of the plurality of light rays. A first lower passageway is positioned below the plane opposite the first upper passageway and has a longitudinal plane that extends at the first angle relative to the plane when the lighting apparatus is viewed in the cross-sectional plane. The first lower passageway is sized and shaped to receive a second light ray of the plurality of light rays. A second upper passageway is positioned above the plane and has a longitudinal plane that extends at a second angle relative to the plane when the lighting apparatus is viewed in the cross-sectional plane. The first upper passageway sized and shaped to redirect the first light ray into the second upper passageway. A second lower passageway is positioned below the plane and has a longitudinal plane that extends at the second angle relative to the plane when the lighting apparatus is viewed in the cross-sectional plane. The first lower passageway is sized and shaped to redirect the second light ray into the second lower passageway. An upper exit surface is positioned at an end of the second upper passageway. The first light ray exits the lighting apparatus through the upper exit surface. A lower exit surface is positioned at an end of the second lower passageway. The second light ray exits the lighting apparatus through the lower exit surface.

In one embodiment, the first angle is an oblique angle and the second angle is an oblique angle.

In one embodiment, the upper exit surface and the lower exit surface extend at a third angle relative to the plane when the lighting apparatus is viewed in a cross-sectional plane. In one embodiment, the third angle is an oblique angle.

In one embodiment, the longitudinal plane of the second upper passageway extends at a fourth angle relative to the longitudinal plane of the first upper passageway when the lighting apparatus is viewed in a cross-sectional plane. In one embodiment, the longitudinal plane of the second lower passageway extends at the fourth angle relative to the longitudinal plane of the first lower passageway when the lighting apparatus is viewed in a cross-sectional plane.

In one embodiment, the lighting apparatus includes a notch defined by a surface. The light source is positioned within the notch. The notch is sized and shaped to refract the first light ray into the first upper passageway, and refract the second light ray into the first lower passageway. In one embodiment, the surface of the notch includes a curved end and a pair of substantially linear sidewalls extending from the curved end when the lighting apparatus is viewed in a cross-sectional plane.

In one embodiment, the first upper passageway is sized and shaped to internally reflect the first light ray therethrough. In one embodiment, the first lower passageway is sized and shaped to internally reflect the second light ray therethrough. In one embodiment, the second upper passageway is sized and shaped to internally reflect the first light ray therethrough. In one embodiment, the second lower passageway is sized and shaped to internally reflect the second light ray therethrough.

In yet another aspect, a lighting assembly includes a housing having a cavity formed therein and defined by a plurality of sidewalls extending from a back wall. A first light source is positioned within the cavity and secured to the back wall. A lighting apparatus is positioned within the cavity adjacent to the first light source and secured to the back wall. The lighting apparatus includes a second light source configured to emit a plurality of light rays. The second light source being is positioned in a plane when the lighting apparatus is viewed in a cross-sectional plane. A first upper passageway is positioned above the plane and has a longitudinal plane that extends at a first angle relative to the plane when the lighting apparatus is viewed in the cross-sectional plane. The first upper passageway is sized and shaped to receive a first light ray of the plurality of light rays. A first lower passageway is positioned below the plane opposite the first upper passageway and has a longitudinal plane that extends at the first angle relative to the plane when the lighting apparatus is viewed in the cross-sectional plane. The first lower passageway is sized and shaped to receive a second light ray of the plurality of light rays. A second upper passageway is positioned above the plane and has a longitudinal plane that extends at a second angle relative to the plane when the lighting apparatus is viewed in the cross-sectional plane. The first upper passageway sized and shaped to redirect the first light ray into the second upper passageway. A second lower passageway is positioned below the plane and has a longitudinal plane that extends at the second angle relative to the plane when the lighting apparatus is viewed in the cross-sectional plane. The first lower passageway is sized and shaped to redirect the second light ray into the second lower passageway. An upper exit surface is positioned at an end of the second upper passageway. The first light ray exits the lighting apparatus through the upper exit surface. A lower exit surface is positioned at an end of the second lower passageway. The second light ray exits the lighting apparatus through the lower exit surface. A transparent cover is positioned on the housing and encloses the first light source and the lighting apparatus within the cavity.

### BRIEF DESCRIPTION OF THE DRAWINGS

The foregoing and other features of the various embodiments of the methods and apparatuses described herein will become more apparent from the following detailed description and the accompanying drawings in which:

FIG. 1 is a perspective view of a vehicle in accordance with an embodiment;

FIG. 2 is a perspective view of the lighting assembly shown in FIG. 1;

FIG. 3 is a perspective view of the lighting assembly shown in FIG. 2 and having the cover removed;

FIG. 4 is an elevation view of the lighting apparatus shown in FIG. 3;

FIG. 5 is a perspective view of the lighting apparatus shown in FIG. 4;

FIG. 6 is a perspective view of a notch formed in the lighting apparatus shown in FIG. 5;

FIG. 7 is an expanded view of the notch taken about section A shown in FIG. 6;

FIG. 8 is a cross-sectional view of the notch shown in FIG. 7 and having light rays passing through and being refracted by a surface that defines the notch;

FIG. 9 is a cross-sectional view of the lighting apparatus taken about the line B-B shown in FIG. 5; and

FIG. 10 is a diagrammatic view of the lighting apparatus having light rays internally reflected therethrough.

### DETAILED DESCRIPTION OF THE DRAWINGS

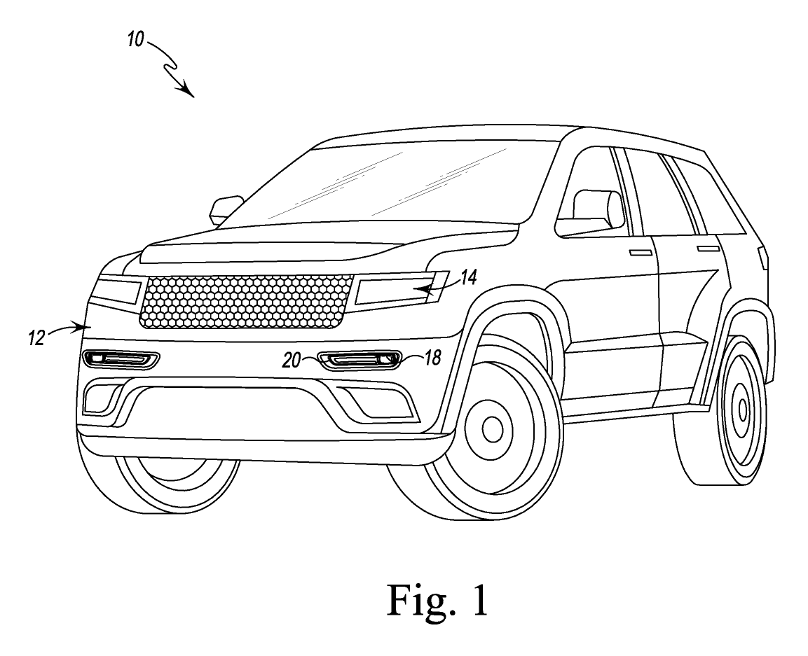

Referring to FIG. 1, a vehicle 10 is provided. The vehicle 10 is illustrated as an automobile; however, the present disclosure may also be applicable to other vehicles, for example, motorcycles, all-terrain vehicles, mopeds, scooters, buses, trucks, and the like. The vehicle 10 includes a front end 12 that faces the direction of travel when the vehicle 10 is operated in a forward-moving gear. The front end 12 of the vehicle 10 includes a plurality of lights for aiding vision when traveling in certain conditions. Headlamps 14 are provided for providing light in the direction of travel during dark conditions, for example evening, rain, snow, or other inclement weather conditions. A lighting assembly 16 is positioned below the headlamps 14. The lighting assembly 16 includes a fog lamp 18 for foggy driving conditions and a lighting apparatus 20 for aesthetics. Lighting apparatus 20 may also be suitable for providing visibility of the vehicle 10 to other vehicles.

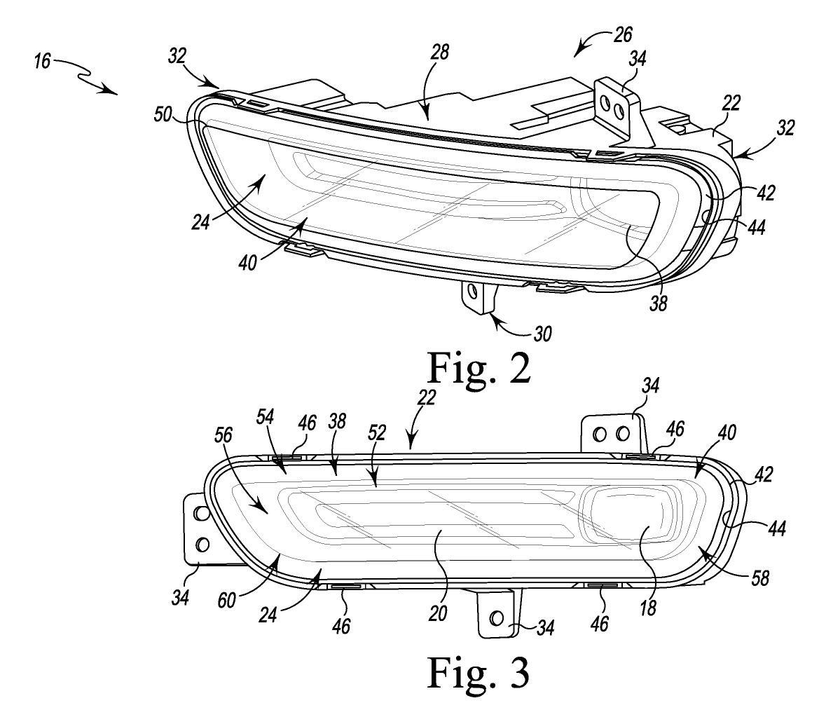

Referring to FIG. 2, the lighting assembly 16 includes a housing 22 having a front end 24 and a back end 26. The housing 22 extends between the front end 24 and the back end 26. Particularly, the housing 22 includes a top wall 28, an opposite bottom wall 30, and a pair of sidewalls 32 extending between the front end 24 and the back end 26. Flanges 34 extend from the housing 22 and include apertures 36 therethrough. A first flange 34 extends from the top wall 28, a second flange 34 extends from the bottom wall 30, and a third flange 34 extends from one of the sidewalls 32. The flanges 34 are configured to secure the lighting assembly 16 within the front end 12 of the vehicle 10. Specifically, the housing 22 is configured position within a cavity formed in the front end 12 of the vehicle 10. The housing 22 positions within the vehicle 10 such that the front end 24 of the housing 22 extends from, or alternatively flush with, the front end 12 of the vehicle 10. The apertures 36 of the flanges 34 receive a fastening mechanism, i.e. a screw or bolt, therethrough to secure the lighting assembly 16 to the vehicle. When the lighting assembly 16 is coupled to the vehicle 10, wires or other electrically components may extend through the back end 26 of the housing 22 and electrically couple to an electrical source of the vehicle 10.

The front end 24 of the housing 22 includes a front face 40 having a groove 42 formed around a perimeter thereof. The groove 42 is defined by a plurality of sidewalls 44 formed in a substantially U or C shape. Tabs 46 are positioned around the groove 42. A transparent cover 38 is secured over the front end 24 of the housing 22. The transparent cover 38 includes a front face 48 and a rim 50 extending around a perimeter of the front face 48. The rim 50 of the transparent cover 38 is positioned within the groove 42 and retained by the sidewalls 44 of the groove 42. A friction fit between the sidewalls 44 of the groove 42 and the rim 50 of the transparent cover 38 holds the transparent cover 38 in position on the front end 24 of the housing 22. Additionally, the tabs 46 also engage the rim 50 of the transparent cover 38 to further secure the transparent cover 38 to the housing 22.

Referring to FIG. 3, a cavity 52 is formed in the front end 24 of the housing 22. The front face 40 of the housing 22 extends around the cavity 52. The cavity 52 includes sidewalls 54 that extend from the front face 40 into the housing 22 to a back wall 56. The fog lamp 18 and the lighting apparatus 20 are positioned within the cavity 52. In the illustrative embodiment, the fog lamp 18 and the lighting apparatus 20 are secured to the back wall 56 of the cavity 52. In one embodiment, the back wall 56 of the cavity 52 includes an opening (not shown) that the fog lamp 18 is positioned within. The opening enables wiring and electrical components from the fog lamp 18 to be directed into the housing 22, and ultimately to a power source of the vehicle 10. In one embodiment, the back wall 56 of the cavity 52 includes an opening (not shown) that the lighting apparatus 20 is positioned within. The opening enables wiring and electrical components from the lighting apparatus 20 to be directed into the housing 22, and ultimately to a power source of the vehicle 10.

The fog lamp 18 is positioned on a first end 58 of the cavity 52. The lighting apparatus 20 extends from a second end 60 of the cavity 52 to the fog lamp 18. Accordingly, the lighting apparatus 20 and the fog lamp 18, collectively, extend across a length of the back wall 56 of the cavity 52. In the illustrative embodiment, the fog lamp 18 and the lighting apparatus 20 extend forward from the back wall 56 toward the front face 40 of the housing 22. In one embodiment, the lighting apparatus 20 and the fog lamp 18 are positioned back of the front face 40 of the housing 22 such that the transparent cover 38 may be secured to the housing 22 and cover the lighting apparatus 20 and the fog lamp 18, as shown in FIG. 2.

The lighting apparatus 20 and the fog lamp 18 are configured to emit light therefrom. The light emitted from the lighting apparatus 20 and the fog lamp 18 is emitted through the transparent cover 38. In one embodiment, the back wall 56 and/or the sidewalls 54 of the cavity 52 may be formed from a reflective material to intensify the light emitted from the lighting apparatus 20 and the fog lamp 18.

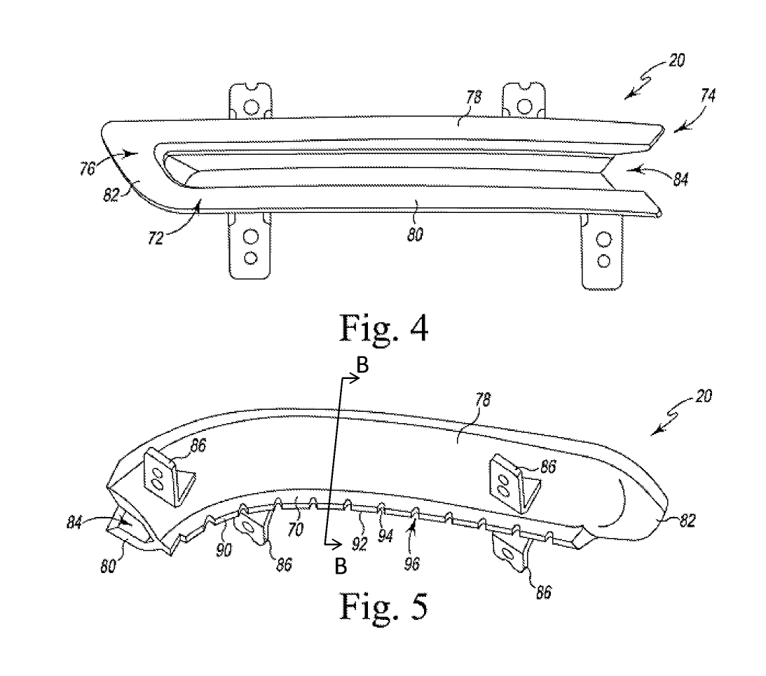

Referring to FIGS. 4 and 5, the lighting apparatus 20 includes a base 70 and an opposite front face 72. The lighting apparatus 20 also includes an open end 74 and a closed end 76. An upper lighting passageway 78 and a lower lighting passageway 80 extend between the base 70 and the front face 72, and between the open end 74 and the closed end 76. An end lighting passage 82 extends along the closed end 76 between the upper lighting passageway 78 and the lower lighting passageway 80. The upper lighting passageway 78, the lower lighting passageway 80, and the end lighting passage 82 define a cavity 84. The cavity 84 is closed at the closed end 76 of the lighting apparatus 20, or at the end lighting passage 82, and open at the open end 74 of the lighting apparatus 20. The cavity 84 is also open at the front face 72 of the lighting apparatus 20.

The upper lighting passageway 78 and the lower lighting passageway 80 each include flanges 86 extending outward therefrom. The flanges 86 include apertures 88 to receive a screw, bolt, or the like. The lighting apparatus 20 is secured to the lighting assembly 16 housing 22 via fastening mechanisms secured to the flanges 86.

The base 70 of the lighting apparatus 20 extends substantially along a length of the lighting apparatus 20 between the open end 74 and the closed end 76. The base 70 includes a surface 90 extending along a length of the base 70. The surface 90 includes a plurality of outer surfaces 92 that are substantially curved. The surface 90 also includes a plurality of notch surfaces 94 positioned between adjacent outer surfaces 92 and defining notches 96 in the base 70.

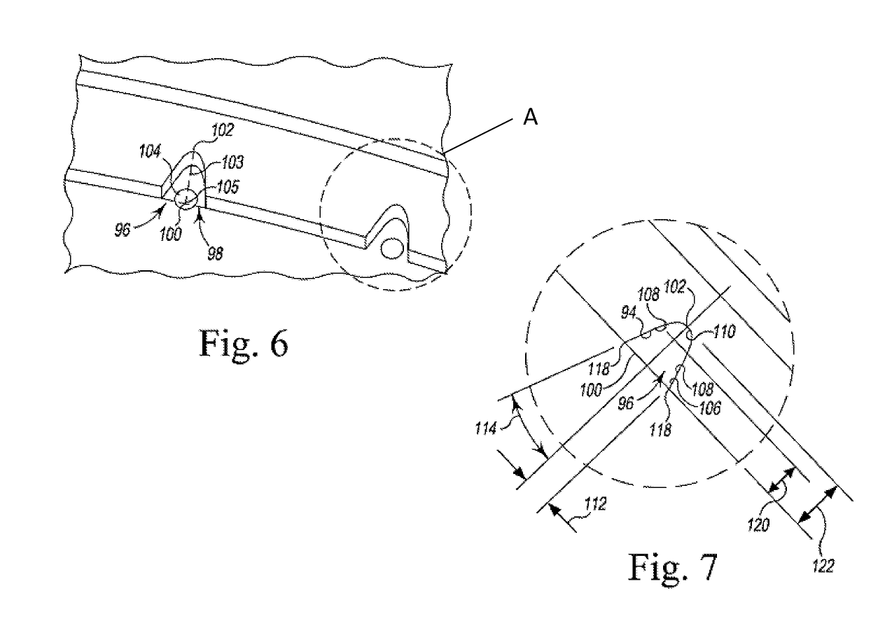

Referring to FIG. 6, the notches 96 include an opening 98 formed at an imaginary line 100 extending between adjacent outer surfaces 92 and an apex 102. The apex 102 is positioned along a longitudinal axis 103 that extends from a center 105 of the imaginary line 100 substantially perpendicular to the imaginary line 100. The notches 96 are configured to have a light source 104, for example a light emitting diode, positioned therein. The light source 104 is positioned at the opening 98 of the notch 96 on the imaginary line 100. The light source 104 emits light rays in the direction of the notch surface 94.

Referring to FIG. 7, the notch surface 94 extends along a notch wall 106 that defines the notch 96. The notch wall 106 includes a pair of linear sidewalls 108 and a curved wall 110. The curved wall 110 includes the apex 102 of the notch 96 and a pair of ends 118, wherein the apex 102 is substantially centered between the ends 118. In one embodiment, the curved wall 110 includes a parabolic curve. In one embodiment, the curved wall 110 has a constant radius. The apex 102 of the curved wall 110 is positioned a distance 122 from the imaginary line 100 taken along the longitudinal axis 103. In one embodiment, the distance 122 is approximately 2.2 mm. Each end 118 of the curved wall 110 is positioned a distance 120 from the imaginary line 100 taken along the longitudinal axis 103. In one embodiment, the distance 120 is approximately 1.5 mm.

Each linear sidewall 108 extends from an outer surface 92 of the base 70 to the curved wall 110. Each linear sidewall 108 is positioned a distance 112 from the center 105 of the imaginary line 100. In some embodiments, the distance 112 is approximately 1.25 mm. Accordingly, a distance between each linear sidewall 108 is approximately 2.5 mm. The linear sidewalls 108 each extend at an angle 114 from longitudinal axis 103. In one embodiment, the angle 114 is approximately 18.2 degrees. Each linear sidewall 108 terminates and an end 118 of the curved wall 110.

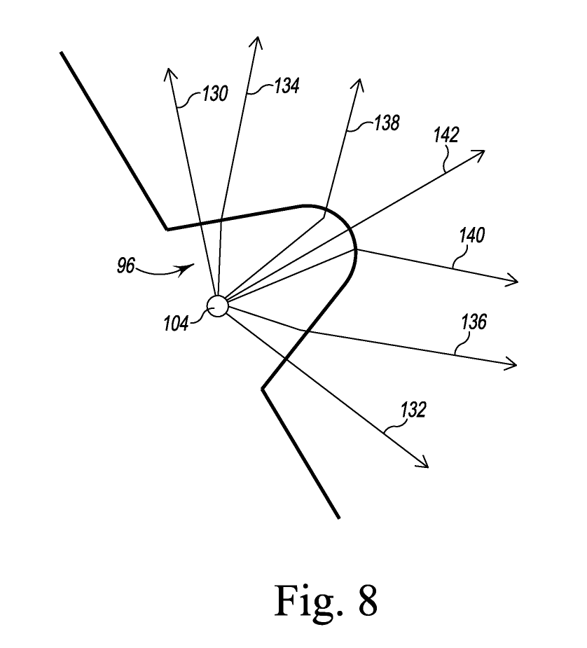

Referring to FIG. 8, the light source 104 emits light rays in the direction of the notch wall 106 of the notch 96. For example, a light ray 130 is directed toward a first linear sidewall 108, and a light ray 132 is directed toward the other linear sidewall 108. In the illustrative embodiments, each light ray 130 and 132 passes directly through the linear sidewall 108 without being refracted. In another example, a light ray 134 is directed toward the first linear sidewall 108, and a light ray 136 is directed toward the other linear sidewall 108. In the illustrative embodiment, each light ray 134 and 136 is refracted by the respective linear sidewall 108. It should be noted that in any embodiment, the linear sidewall may be coated or otherwise treated to promote refraction of the light rays.

In another example, light rays 138, 140, and 142 are emitted toward the curved wall 110 of the notch 96. In the illustrative embodiment, the light ray 140 passes through the curved wall 110 without being refracted. Additionally, light ray 138 is refracted in a first direction and light ray 142 is refracted in a second direction.

It should be noted that, a discussed in more detail below, the notch 96 directs the light rays into different sections of the lighting apparatus 20. For example, light rays 130, 134, and 138 may be directed into the upper lighting passageway 78 of the lighting apparatus 20. Likewise, light rays 132, 136, and 142 may be directed into the lower lighting passageway 80 of the lighting apparatus 20.

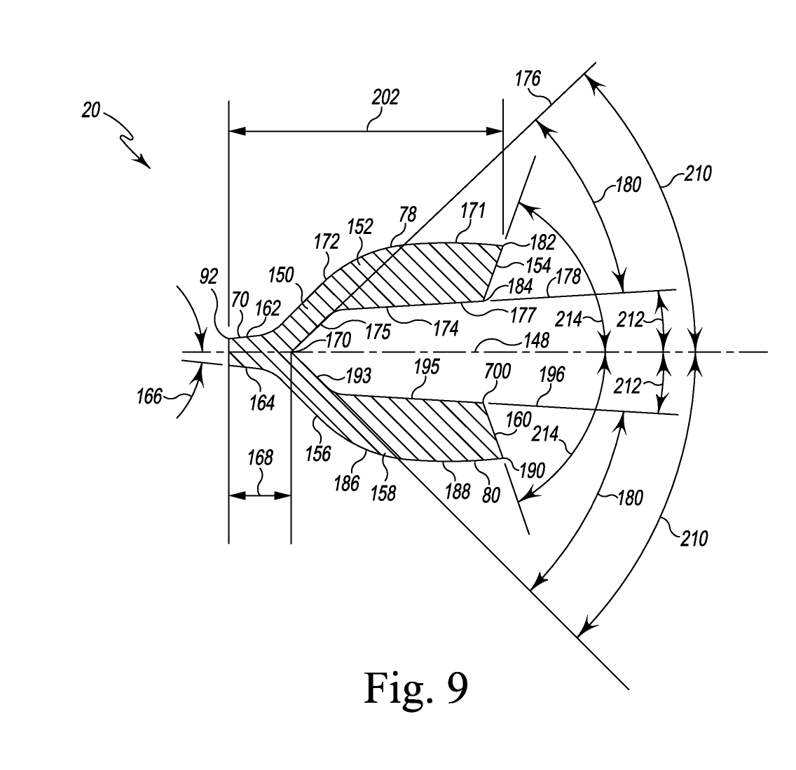

Referring to FIG. 9, the lighting apparatus 20 includes the base 70, the upper lighting passageway 78 and the lower lighting passageway 80 extending therefrom. A plane 148 extends between the upper lighting passageway 78 and the lower lighting passageway 80. The light source 104 is configured to be positioned within the plane 148. The upper lighting passageway 78 includes a first upper passageway 150 extending from the base 70 and a second upper passageway 152 extending from the first upper passageway 150. An upper exit surface 154 is positioned at an end of the second upper passageway 152. The lower lighting passageway 80 includes a first lower passageway 156 extending from the base 70 and a second lower passageway 158 extending from the first lower passageway 156. A lower exit surface 160 is positioned at an end of the second lower passageway 158.

The base 70 includes an upper sidewall 162 positioned above the plane 148 and a lower sidewall 164 positioned below the plane 148. The upper sidewall 162 and the lower sidewall 164 each extend at angle 166 with respect to the plane 148. In one embodiment, the angle 166 is approximately 6.5 degrees. The base 70 extends a distance 168 along the plane 148 from the outer surface 92 to a junction 170 between the upper lighting passageway 78 and the lower lighting passageway 80. In one embodiment, the distance 168 is approximately 8.4 mm.

The upper lighting passageway 78 is defined at a top 171 by an outer sidewall 172 that extends from the upper sidewall 162 of the base 70 to the an upper end 182 of the upper exit surface 154. The outer sidewall 172 is curved and extends along both the first upper passageway 150 and the second upper passageway 152. The upper lighting passageway 78 is further defined at a bottom 174 by a first linear sidewall 175 defined by a longitudinal plane 176 and extending along the first upper passageway 150 and a second linear sidewall 177 defined by a longitudinal plane 178 and extending at an angle 180 from the first linear sidewall along the second upper passageway 152 to a lower end 184 of the upper exit surface 154. The angle 180 is an oblique angle. In one embodiment, the angle 180 is approximately 41.1 degrees. The upper end 182 of the upper exit surface 154 is positioned a distance 202 along the plane 148 from the outer surface 92 of the base 70. In one embodiment, the distance 202 is approximately 36.5 mm.

The first upper passageway 150 is positioned above the plane 148. The longitudinal plane 176 extends at an angle 210 relative to the plane 148. The angle 210 is an oblique angle. In one embodiment, the angle 210 is approximately 45 degrees. The second upper passageway 152 is also positioned above the plane 148. The longitudinal plane 178 extends at an angle 212 relative to the plane 148. The angle 212 is an oblique angle. In one embodiment, the angle 212 is approximately 3.9 degrees. The upper exit surface 154 extends at an angle 214 relative to the plane 148. The angle 214 is an oblique angle. In one embodiment, the angle 214 is approximately 70.3 degrees.

The lower lighting passageway 80 is defined at a bottom 186 by an outer sidewall 188 that extends from the lower sidewall 164 of the base 70 to the a lower end 190 of the lower exit surface 160. The outer sidewall 188 is curved and extends along both the first lower passageway 156 and the second lower passageway 158. The lower lighting passageway 80 is further defined at a top 192 by a first linear sidewall 193 defined by a longitudinal plane 194 and extending along the first lower passageway 156 and a second linear sidewall 195 defined by a longitudinal plane 196 and extending at the angle 180 from the first linear sidewall 193 along the second lower passageway 158 to an upper end 200 of the lower exit surface 160. The lower end 190 of the lower exit surface 160 is positioned the distance 202 along the plane 148 from the outer surface 92 of the base 70.

The first lower passageway 156 is positioned below the plane 148 opposite the first upper passageway 150. The longitudinal plane 194 extends at the angle 210 relative to the plane 148. The second lower passageway 158 is positioned below the plane 148 opposite the second upper passageway 152. The longitudinal plane 196 extends at the angle 212 relative to the plane 148. The lower exit surface 160 extends at the angle 214 relative to the plane 148.

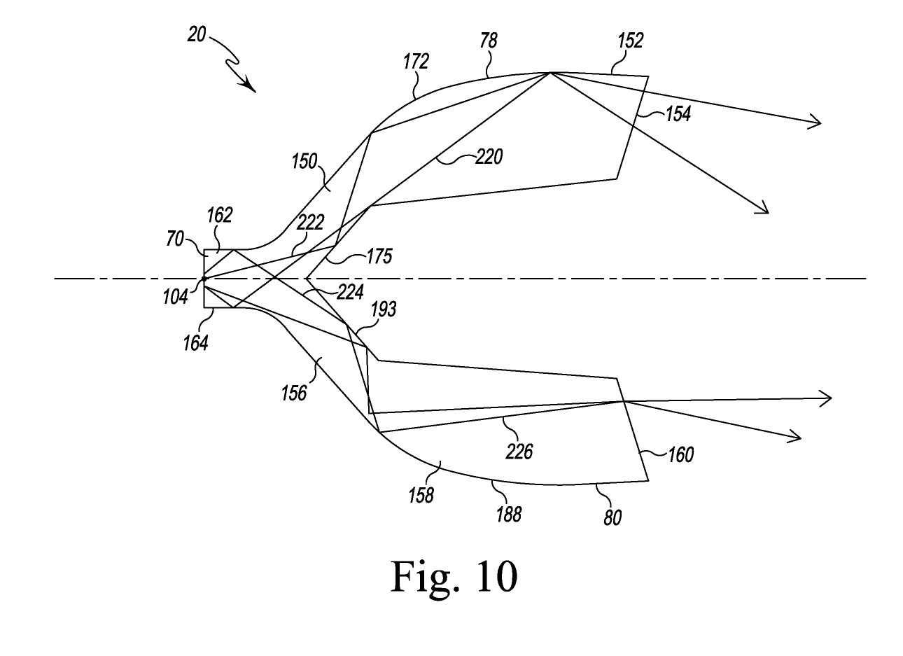

Referring to FIG. 10, the upper lighting passageway 78 and the lower lighting passageway 80 are sized and shaped to direct light rays therethrough to the upper exit surface 154 and the lower exit surface 160, respectively. As described above, the notch 96 is sized and shaped to direct light rays emitted from the light source 104 into one of the upper lighting passageway 78 and the lower lighting passageway 80. The light rays are directed directly into one of the upper lighting passageway 78 or the lower lighting passageway 80 or are refracted by the notch surface 94 into one of the upper lighting passageway 78 or the lower lighting passageway 80. It should be noted that some light rays may not be direct into one of the upper lighting passageway 78 or the lower lighting passageway 80 and may pass through the cavity 84 of the lighting apparatus 20; however, such light rays are minimal and may not be visible when viewing the lighting apparatus 20.

As illustrated in FIG. 10, a light ray 220 is directed off the lower sidewall 164 of the base 70 and through the first upper passageway 150. In one embodiment, the light ray 220 is internally reflected off of the lower sidewall 164 of the base 70. As used herein, the term “internally reflected” is used to describe a light ray that engages a surface or wall at such an angle that the entire light ray is reflected within the lighting apparatus 20 without any light from the light ray being refracted out of the lighting apparatus 20. The light ray 220 passes through the first upper passageway 150 and into the second upper passageway 152. In the second upper passageway 152, the light ray 220 is directed by the outer sidewall 172 of the upper lighting passageway 78 toward the upper exit surface 154. In one embodiment, the outer sidewall 172 is angled or curved such that the light ray 220 is internally reflected toward the upper exit surface 154. In some embodiments, the light ray 220 passes directly through the upper exit surface 154 without being reflected or refracted. In other embodiment, the upper exit surface 154 may include a surface coating that refracts or diffracts the light ray 220 as it exits the upper exit surface 154.

Another light ray 222 is directed off the first linear sidewall 175 the first upper passageway 150 and toward the outer sidewall 172 within the first upper passageway 150. In one embodiment, the light ray 222 is internally reflected off of the first linear sidewall 175. The light ray 220 passes into the second upper passageway 152. In the second upper passageway 152, the light ray 222 is directed by the outer sidewall 172 toward the upper exit surface 154. In one embodiment, the light ray 222 is internally reflected toward and through the upper exit surface 154.

Yet another a light ray 224 is directed off the upper sidewall 162 of the base 70 and through the first lower passageway 156. In one embodiment, the light ray 224 is internally reflected off of the upper sidewall 162 of the base 70. The light ray 224 passes through the first lower passageway 156 and into the second lower passageway 158. In the second lower passageway 158, the light ray 224 is directed by the outer sidewall 188 of the lower lighting passageway 80 toward the lower exit surface 160. In one embodiment, the outer sidewall 188 is angled or curved such that the light ray 224 is internally reflected toward the lower exit surface 160. In some embodiments, the light ray 224 passes directly through the lower exit surface 160 without being reflected or refracted. In other embodiment, the lower exit surface 160 may include a surface coating that refracts or diffracts the light ray 224 as it exits the lower exit surface 160.

A further light ray 226 is directed off the first linear sidewall 193 the first lower passageway 156 and toward the outer sidewall 188 within the first lower passageway 156. In one embodiment, the light ray 226 is internally reflected off of the first linear sidewall 193. The light ray 226 passes into the second lower passageway 158. In the second lower passageway 158, the light ray 226 is directed by the outer sidewall 188 toward the lower exit surface 160. In one embodiment, the light ray 226 is internally reflected toward and through the lower exit surface 160.

It should be noted that, while FIG. 10 is described with respect to four light rays, a plurality of light rays are emitted from the light source 104. The lighting apparatus 20 and components thereof are sized and shaped to internally reflect the plurality of light rays therethrough and emit the light rays from one of the upper exit surface 154 or the lower exit surface 160.

It should also be noted that any of the surfaces described above may include diffuse materials and/or texture to facilitate randomizing the light rays to give a smoother lit appearance.

Although certain illustrative embodiments have been described in detail above, variations and modifications exist within the scope and spirit of this disclosure as described and as defined in the following claims.

What is claimed is:

1. A method of illumination comprising:
energizing a light source of a lighting apparatus to emit a plurality of light rays, the light source being positioned in a plane when the lighting apparatus is viewed in a cross-sectional plane,
directing a first light ray of the plurality of light rays into a first upper passageway positioned above the plane, the first upper passageway having a longitudinal plane that extends at a first angle relative to the plane when the lighting apparatus is viewed in the cross-sectional plane,
directing a second light ray of the plurality of light rays into a first lower passageway positioned below the plane opposite the first upper passageway, the first lower passageway having a longitudinal plane that extends at the first angle relative to the plane when the lighting apparatus is viewed in the cross-sectional plane,
redirecting the first light ray from the first upper passageway into a second upper passageway positioned above the plane, the second upper passageway having a longitudinal plane that extends at a second angle relative to the plane when the lighting apparatus is viewed in the cross-sectional plane, and
redirecting the second light ray from the second upper passageway into a second lower passageway positioned below the plane, the second lower passageway having a longitudinal plane that extends at the second angle relative to the plane when the lighting apparatus is viewed in the cross-sectional plane,
wherein the first light ray exits the lighting apparatus through an upper exit surface positioned at an end of the second upper passageway and the second light ray exits the lighting apparatus through a lower exit surface positioned at an end of the second lower passageway.

2. The method of claim 1 further comprising energizing the light source to emit the plurality of light rays through a surface that defines a notch in which the light source is positioned.

3. The method of claim 2 further comprising:
directing the first light ray into the first upper passageway with the base surface; and
directing the second light ray into the first lower passageway with the base surface.

4. The method of claim 3 further comprising:
refracting the first light ray into the first upper passageway with the base surface; and
refracting the second light ray into the first lower passageway with the base surface.

5. The method of claim 1 further comprising:
internally reflecting the first light ray through the first upper passageway; and
internally reflecting the second light ray through the first lower passageway.

6. The method of claim 1 further comprising:
internally reflecting the first light ray through the second upper passageway; and
internally reflecting the second light ray through the second lower passageway.

7. A lighting apparatus comprising:
a light source configured to emit a plurality of light rays, the light source being positioned in a plane when the lighting apparatus is viewed in a cross-sectional plane,
a first upper passageway positioned above the plane and having a longitudinal plane that extends at a first angle relative to the plane when the lighting apparatus is viewed in the cross-sectional plane, the first upper passageway sized and shaped to receive a first light ray of the plurality of light rays,
a first lower passageway positioned below the plane opposite the first upper passageway and having a longitudinal plane that extends at the first angle relative to the plane when the lighting apparatus is viewed in the cross-sectional plane, the first lower passageway sized and shaped to receive a second light ray of the plurality of light rays,
a second upper passageway positioned above the plane and having a longitudinal plane that extends at a second angle relative to the plane when the lighting apparatus is viewed in the cross-sectional plane, the first upper passageway sized and shaped to redirect the first light ray into the second upper passageway,
a second lower passageway positioned below the plane and having a longitudinal plane that extends at the second angle relative to the plane when the lighting apparatus is viewed in the cross-sectional plane, the first lower passageway sized and shaped to redirect the second light ray into the second lower passageway,
an upper exit surface positioned at an end of the second upper passageway, wherein the first light ray exits the lighting apparatus through the upper exit surface, and
a lower exit surface positioned at an end of the second lower passageway, wherein the second light ray exits the lighting apparatus through the lower exit surface.

8. The lighting apparatus of claim 7, wherein the first angle is an oblique angle, and the second angle is an oblique angle.

9. The lighting apparatus of claim 7, wherein the upper exit surface and the lower exit surface extend at a third angle relative to the plane when the lighting apparatus is viewed in a cross-sectional plane.

10. The lighting apparatus of claim 9, wherein the third angle is an oblique angle.

11. The lighting apparatus of claim 7, wherein:
the longitudinal plane of the second upper passageway extends at a fourth angle relative to the longitudinal plane of the first upper passageway when the lighting apparatus is viewed in a cross-sectional plane, and
the longitudinal plane of the second lower passageway extends at the fourth angle relative to the longitudinal plane of the first lower passageway when the lighting apparatus is viewed in a cross-sectional plane.

12. The lighting apparatus of claim 7, further comprising a notch defined by a surface, the light source positioned within the notch, the surface of the notch is sized and shaped to:
refract the first light ray into the first upper passageway, and
refract the second light ray into the first lower passageway.

13. The lighting apparatus of claim 7, wherein the surface of the notch includes a curved end and a pair of substantially linear sidewalls extending from the curved end when the lighting apparatus is viewed in a cross-sectional plane.

14. The lighting apparatus of claim 7, wherein:
the first upper passageway is sized and shaped to internally reflect the first light ray therethrough; and
the first lower passageway is sized and shaped to internally reflect the second light ray therethrough.

15. The lighting apparatus of claim 7, wherein:
the second upper passageway is sized and shaped to internally reflect the first light ray therethrough; and
the second lower passageway is sized and shaped to internally reflect the second light ray therethrough.

16. A lighting assembly comprising:
a housing having a cavity formed therein and defined by a plurality of sidewalls extending from a back wall,
a first light source positioned within the cavity and secured to the back wall,
a lighting apparatus positioned within the cavity adjacent to the first light source and secured to the back wall, the lighting apparatus comprising:
a second light source configured to emit a plurality of light rays, the second light source being positioned in a plane when the lighting apparatus is viewed in a cross-sectional plane,
a first upper passageway positioned above the plane and having a longitudinal plane that extends at a first angle relative to the plane when the lighting apparatus is viewed in the cross-sectional plane, the first upper passageway sized and shaped to receive a first light ray of the plurality of light rays,
a first lower passageway positioned below the plane opposite the first upper passageway and having a longitudinal plane that extends at the first angle relative to the plane when the lighting apparatus is viewed in the cross-sectional plane, the first lower passageway sized and shaped to receive a second light ray of the plurality of light rays,
a second upper passageway positioned above the plane and having a longitudinal plane that extends at a second angle relative to the plane when the lighting apparatus is viewed in the cross-sectional plane, the first upper passageway sized and shaped to redirect the first light ray into the second upper passageway,
a second lower passageway positioned below the plane and having a longitudinal plane that extends at the second angle relative to the plane when the lighting apparatus is viewed in the cross-sectional plane, the first lower passageway sized and shaped to redirect the second light ray into the second lower passageway,
an upper exit surface positioned at an end of the second upper passageway, wherein the first light ray exits the lighting apparatus through the upper exit surface, and
a lower exit surface positioned at an end of the second lower passageway, wherein the second light ray exits the lighting apparatus through the lower exit surface, and
a transparent cover positioned on the housing and enclosing the first light source and the lighting apparatus within the cavity.

17. The lighting assembly of claim 16, wherein the upper exit surface and the lower exit surface extend at a third angle relative to the plane when the lighting apparatus is viewed in a cross-sectional plane, wherein the third angle is an oblique angle.

18. The lighting assembly of claim 16, wherein:
the longitudinal plane of the second upper passageway extends at a fourth angle relative to the longitudinal plane of the first upper passageway when the lighting apparatus is viewed in a cross-sectional plane, and
the longitudinal plane of the second lower passageway extends at the fourth angle relative to the longitudinal plane of the first lower passageway when the lighting apparatus is viewed in a cross-sectional plane.

19. The lighting assembly of claim 16, wherein:
the first upper passageway is sized and shaped to internally reflect the first light ray therethrough; and
the first lower passageway is sized and shaped to internally reflect the second light ray therethrough.

20. The lighting assembly of claim 16, wherein:
the second upper passageway is sized and shaped to internally reflect the first light ray therethrough; and
the second lower passageway is sized and shaped to internally reflect the second light ray therethrough.
